(19) United States
(12) Patent Application Publication
(10) Pub. No.: US 2021/0027606 A1
(43) Pub. Date: Jan. 28, 2021

(54) VIBRATION CONTROL FOR HYDROCARBON RECOVERY EQUIPMENT

(71) Applicant: Saudi Arabian Oil Company, Dhahran (SA)

(72) Inventors: Ali Nasser Al-Meqbel, Riyadh (SA); Abdulrahman M. Al Majid, Dammam (SA)

(21) Appl. No.: 16/518,293

(22) Filed: Jul. 22, 2019

(51) Int. Cl. G08B 21/18; E21B 47/00; E21B 41/00; G01H 1/00

(52) U.S. Cl. CPC G08B 21/182; G01H 1/003; E21B 41/0021; E21B 47/00

(57) ABSTRACT

A vibration sensor connected to a hydrocarbon recovery equipment operating on a surface of the Earth senses a portion of vibrations of the hydrocarbon recovery equipment when performing operations to recover hydrocarbons from a subterranean zone. The vibration sensor transmits the portion of vibrations to a vibration controller on the surface. The vibration controller is disposed on the surface of the Earth. The vibration controller compares the portion of vibrations sensed by the vibration sensor to a stored threshold vibration level associated with the hydrocarbon recovery equipment. Based on a result of the comparing, the vibration controller transmits an alert signal to an alarm system on the surface. In response to receiving the alert signal, the alarm system emits an acoustic or optical alarm signal representing the result of the comparing.

### TECHNICAL FIELD

This disclosure relates to hydrocarbon production systems, for example, production equipment deployed at the surface of a wellbore to form the wellbore or produce hydrocarbons through the wellbore.

### BACKGROUND

Hydrocarbons trapped in subsurface reservoirs are retrieved by first forming wellbores from the surface of the Earth to the subsurface reservoirs and then producing (that is, raising) the trapped hydrocarbons through the wellbores to the surface. Different types of equipment are used to form the wellbores and to produce the hydrocarbons. Some equipment can be disposed on the surface while others can be disposed within the wellbore. Such equipment, which includes, for example, top drives, rig pumps, power engines (such as, generators) and agitators, vibrate during operation.

### SUMMARY

This disclosure describes technologies relating to vibration control for hydrocarbon recovery equipment.

Certain aspects of the subject matter described here can be implemented as a method. A vibration sensor connected to a hydrocarbon recovery equipment operating on a surface of the Earth senses a portion of vibrations of the hydrocarbon recovery equipment when performing operations to recover hydrocarbons from a subterranean zone. The vibration sensor transmits the portion of vibrations to a vibration controller on the surface. The vibration controller is disposed on the surface of the Earth. The vibration controller compares the portion of vibrations sensed by the vibration sensor to a stored threshold vibration level associated with the hydrocarbon recovery equipment. Based on a result of the comparing, the vibration controller transmits an alert signal to an alarm system on the surface. In response to receiving the alert signal, the alarm system emits an acoustic or optical alarm signal representing the result of the comparing.

An aspect combinable with any other aspect can include the following features. The vibration sensor is directly connected to the hydrocarbon recovery equipment. The portion of vibrations is sensed by acoustic conduction.

An aspect combinable with any other aspect can include the following features. The vibration sensor transforms the portion of vibrations into electrical signals. The electrical signals are transmitted to the vibration controller.

An aspect combinable with any other aspect can include the following features. The electrical signals are transmitted to the vibration controller through wired connections between the vibration sensor and the vibration controller.

An aspect combinable with any other aspect can include the following features. The stored threshold vibration level associated with the hydrocarbon recovery equipment is based on a resonance frequency of the hydrocarbon recovery equipment. The stored threshold vibration level is stored as an electrical signal value.

An aspect combinable with any other aspect can include the following features. The alert signal is an electrical signal transmitted to the alarm system through wired connections.

An aspect combinable with any other aspect can include the following features. The hydrocarbon recovery equipment is a first hydrocarbon recovery equipment of multiple hydrocarbon recovery equipment. Each equipment operates on the surface and is connected to the vibration controller. The vibration controller stores multiple stored threshold vibration levels, each associated with a respective hydrocarbon recovery equipment. The vibration controller compares vibrations of each hydrocarbon recovery equipment with a respective stored threshold vibration level associated with the hydrocarbon recovery equipment. The vibration controller transmits a respective alert signal associated with the hydrocarbon recovery equipment based on a result of comparing the vibrations of each hydrocarbon recovery equipment with a respective stored threshold vibration level associated with the hydrocarbon recovery equipment.

Certain aspects of the subject matter described here can be implemented as a hydrocarbon recovery equipment vibration control system. The system includes a vibration sensor, a vibration controller and an alarm system. The vibration sensor is connected to a hydrocarbon recovery equipment operating on a surface of the Earth. The vibration sensor can sense a portion of vibrations of the hydrocarbon recovery equipment when performing operations to recover hydrocarbons from a subterranean zone. The vibration controller is disposed on the surface and is connected to the vibration sensor. The vibration controller can receive, from the vibration sensor, the portion of vibrations. The vibration controller can compare the portion of vibrations to a stored threshold vibration level associated with the hydrocarbon recovery equipment. Based on a result of the comparing, the vibration controller can transmit an alert signal. The alarm system is disposed on the surface. The alarm system is connected to the vibration controller. The alarm system can receive, from the vibration controller, the alert signal. In response to receiving the alert signal, the alarm system can emit an acoustic or optical alarm representing the result of the comparing.

An aspect combinable with any other aspect can include the following features. The vibration sensor is directly connected to a portion of the hydrocarbon recovery equipment which experiences more vibration during operation of the hydrocarbon recovery equipment compared to a remainder of the hydrocarbon recovery equipment.

An aspect combinable with any other aspect can include the following features. The vibration sensor is an ultrasonic vibration sensor.

An aspect combinable with any other aspect can include the following features. The vibration sensor includes a transducer that can transform the portion of vibrations to electrical signals.

An aspect combinable with any other aspect can include the following features. The vibration sensor and the vibration controller are connected through wired connections through which the vibration sensor transmits the electrical signals to the vibration controller.

An aspect combinable with any other aspect can include the following features. The vibration controller includes a computer-readable memory to store the stored threshold vibration level as an electrical signal value, and one or more processors to compare a value of the electrical signals to the electrical signal value.

An aspect combinable with any other aspect can include the following features. The stored threshold vibration level associated with the hydrocarbon recovery equipment can be based on a resonance frequency of the hydrocarbon recovery equipment.

Certain aspects of the subject matter described here can be implemented as a hydrocarbon recovery equipment system. The system includes multiple hydrocarbon recovery equipment, each disposed on a surface of the earth and experiencing vibrations when operating on the surface of the Earth to recover hydrocarbons from a subterranean zone. The system includes multiple vibration sensors, each directly attached to a respective hydrocarbon recovery equipment, each of which can sense vibrations of the respective hydrocarbon recovery equipment and transmit the sensed vibrations. The system includes a vibration controller connected to the multiple vibration sensors. The vibration controller can receive multiple sensed vibrations from the respective multiple vibration sensors. The vibration controller can store multiple vibration threshold levels, each associated with a respective hydrocarbon recovery equipment. The vibration controller can compare the multiple sensed vibrations and the multiple vibration threshold levels. The system includes an alarm system connected to the vibration controller. The alarm system can output an acoustic or optical alarm in response to the vibration controller determining that a sensed vibration from any of the multiple hydrocarbon recovery equipment exceeds the respective stored vibration threshold level.

An aspect combinable with any other aspect can include the following features. The multiple hydrocarbon recovery equipment include rotating machines and electric machines.

An aspect combinable with any other aspect can include the following features. Each vibration threshold level associated with a respective hydrocarbon recovery equipment is based on a resonance frequency of a material using which the respective hydrocarbon recovery equipment is made.

An aspect combinable with any other aspect can include the following features. The multiple vibration sensors are connected to the vibration controller through wired connections.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of vibration control system implemented with a first implementation of hydrocarbon recovery equipment.

FIG. 2 is a schematic diagram of vibration control system implemented with a second implementation of hydrocarbon recovery equipment.

FIG. 3 is a flowchart of an example of a process of monitoring vibration in hydrocarbon recovery equipment.

Like reference numbers and designations in the various drawings indicate like elements.

### DETAILED DESCRIPTION

Hydrocarbon recovery refers to the retrieval of hydrocarbons trapped in subterranean zones beneath the surface of the Earth. A subterranean zone can include a formation, a portion of a formation or multiple formations. Recovering hydrocarbons from subterranean zones can include forming wellbores from the surface of the Earth through the subterranean zone to the subsurface hydrocarbon reservoir. Recovering hydrocarbons can also include producing hydrocarbons from the subterranean zone to the surface of the Earth through the wellbore. Such recovery operations are implemented, in part, by equipment disposed on the surface of the Earth, that is, not in the wellbore. The equipment can include, for example, top drives, rig pumps, power engines, electrical machines (for example, motors and generators) and agitators, shale shakers, suction lines, draw works, crown blocks, Kelly drives, rotary tables, to name a few. Such equipment include moving parts which vibrate during operation. While some vibration is acceptable, excessive vibration, particularly in high speed or high torque equipment, can damage the equipment, cause the equipment (and the hydrocarbon recovery operation) to shut down, or be hazardous to the human operators operating the equipment. For example, if a vibration frequency of the equipment matches the resonance frequency of the material with which the equipment is made, the equipment can fail or fall apart.

This disclosure describes vibration control for hydrocarbon recovery equipment, specifically, the equipment disposed on the surface of the Earth (onshore or offshore or both), that is, not in the wellbore. The vibration control techniques are described with reference to equipment disposed on the surface of one wellbore, but can be implemented on similar equipment disposed on the surface of an oilfield that includes multiple wellbores. Implementing the techniques described in this disclosure can reduce vibration-related hazards to equipment and operators of equipment as well as downtime associated with wellbore forming or hydrocarbon production.

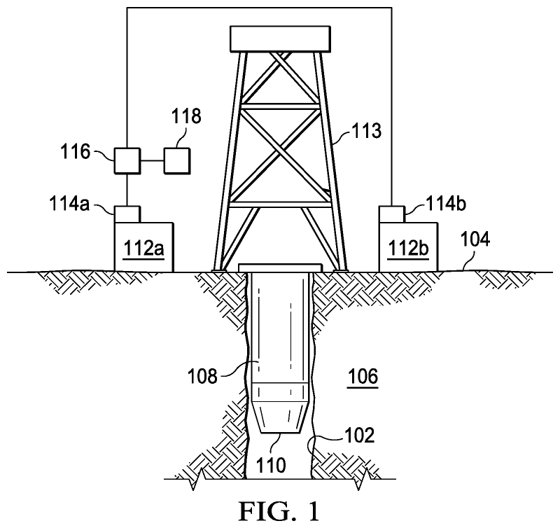

FIG. 1 is a schematic diagram of vibration control system implemented with a first implementation of hydrocarbon recovery equipment. FIG. 1 shows the formation of a wellbore 102 extending from a surface 104 of the Earth into a subterranean zone 106 in which hydrocarbons (not shown) are entrapped. The wellbore formation operations are performed by driving a drill string 108 with a drill bit 110 attached at a downhole end through the subterranean zone 106. The downhole drilling tools (that is, the drill string 108 and the drill bit 110) are controlled by surface equipment 112a, 112b and a drilling rig 113. Whereas two surface equipment are schematically shown in FIG. 1, an actual wellbore formation system can include these and additional equipment, for example, a top drive, pumps to circulate drilling fluid, shale shakers and similar wellbore drilling equipment.

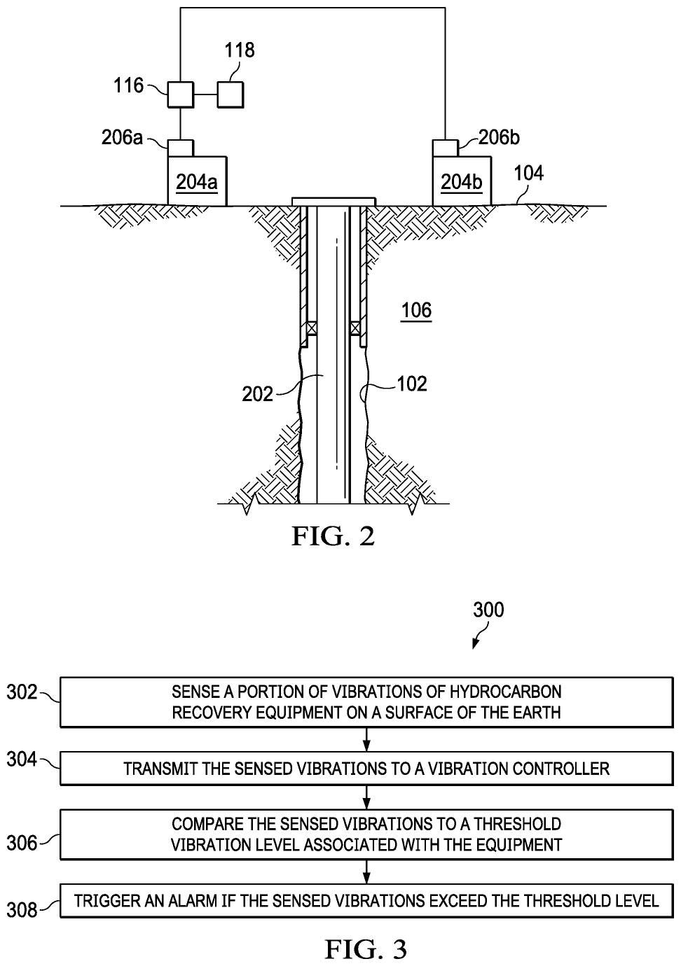

FIG. 2 is a schematic diagram of vibration control system implemented with a second implementation of hydrocarbon recovery equipment. FIG. 2 shows hydrocarbon production through the wellbore 102 formed from the surface 104 of the Earth into the subterranean zone 106. To do so, a production tubing 202 is lowered into the wellbore 102 to extend to the subsurface hydrocarbon reservoir. The hydrocarbon flows to the surface 104 from the subsurface reservoir. In some instances, the pressure of the subterranean zone 106 drives the hydrocarbons to the surface 104 through the production tubing 202. As the pressure of the subterranean zone 106 decreases, secondary recovery techniques (for example, electric submersible pumps) can be implemented to raise the hydrocarbons to the surface. Also, tertiary recovery techniques such as injection wells (not shown) formed adjacent the wellbore 102 can also be implemented to raise the hydrocarbons to the surface. Such hydrocarbon production also involves the use of surface equipment 204a, 204b. Whereas two surface equipment are schematically shown in FIG. 2, an actual wellbore production system can include these and additional equipment, for example, a pump station, a wellhead, a well flowline, a manifold, remote header, pressure relief systems, flare systems or any combination of them.

In some implementations, vibration sensors are connected to the surface equipment. For example, FIG. 1 shows a vibration sensor 114a and a vibration sensor 114b connected to the first hydrocarbon recovery equipment 112a and the second hydrocarbon recovery equipment 112b, respectively. FIG. 2 shows a vibration sensor 206a and a vibration sensor 206b connected to the third hydrocarbon recovery equipment 204a and the fourth hydrocarbon recovery equipment 204b. Each vibration sensor is configured to sense vibrations of the above-surface equipment to which the vibration sensor is attached. The vibrations are caused by physical movement of parts of the equipment during equipment operation to recover hydrocarbons. The frequency of the vibrations that any vibration sensor can sense can fall within any frequency range including an audible frequency range (20 Hertz to 20,000 Hertz) or ultrasonic frequency range (greater than 20,000 Hertz).

In some implementations, each vibration sensor is directly attached to the respective hydrocarbon recovery equipment such that vibration of the equipment is transmitted to the vibration sensor via conduction. In some implementations, a vibration sensor can be indirectly attached to the respective hydrocarbon recovery equipment such that vibration of the equipment is transmitted to the vibration sensor via an intermediate component with minimal or no vibration losses. An operator can attach the vibration sensor to a portion of the equipment that experiences more vibration than a remainder of the equipment. Therefore, the vibration sensor may sense only a portion of the vibration experienced by the entire equipment. Nevertheless, the sensed vibration can represent the maximum vibration (that is, vibration with the largest amplitude or frequency or both) sensed by the entire equipment.

In some implementations, each vibration sensor is configured to transform the sensed vibration into an electrical signal having an amplitude that is based on and is representative of the sensed vibration. Thus, each vibration sensor receives the vibration of the above-surface hydrocarbon recovery equipment to which the vibration sensor is attached during such equipment's hydrocarbon recovery operation, transforms the vibration into an electrical signal representative of the sensed vibration and can transmit the electrical signal to an external device, for example, a vibration controller 116.

As shown in each of FIGS. 1 and 2, the vibration controller 116 can be implemented in any hydrocarbon recovery system. Each vibration sensor is connected to the vibration controller 116, which determines if vibration experienced by a hydrocarbon recovery equipment is within pre-determined limits. In some implementations, the vibration controller 116 includes a computer-readable medium (for example, non-transitory computer-readable medium) storing instructions and other information. The vibration controller 116 also includes one or more processors that can execute the instructions stored by the computer-readable medium to perform the vibration control operations described in this disclosure. The vibration controller 116 and each vibration sensor is connected via wired connections. Through the wired connections, the vibration controller 116 receives vibrations sensed by each vibration sensor. For example, the vibration controller 116 receives multiple electrical signals, each signal originating from a vibration sensor and representing a vibration of the hydrocarbon recovery equipment to which the vibration sensor is connected. In this manner, the vibration controller 116 serves as a central storage and processor for vibrations experienced by all the above-surface hydrocarbon recovery equipment.

For each hydrocarbon recovery equipment, the vibration controller 116 stores a threshold vibration level. This level represents the maximum vibration (for example, maximum frequency or maximum amplitude or both) that the corresponding equipment can experience without risking equipment failure, damage to nearby equipment harm due to vibration or harm to equipment operators. For example, the threshold vibration level for a hydrocarbon recovery equipment is based on a resonance frequency of the hydrocarbon recovery equipment, a maximum vibration level of the attached equipment or a combination of them. For example, if two hydrocarbon recovery equipment are aligned in a sequence or in direct contact, the threshold vibration level will be determined such that the vibration does not affect both equipment. In this manner, the vibration controller 116 stores multiple threshold vibration levels for respective multiple hydrocarbon recovery equipment being implemented.

The vibration controller 116 stores each threshold vibration level as a numerical value that represents the threshold vibration level. In implementations in which a frequency and an amplitude of vibration of a hydrocarbon recovery equipment is sensed by the vibration sensors, the vibration controller 116 can store two threshold vibration levels—one representing maximum frequency, the other representing maximum amplitude. In some implementations, the threshold vibration level is determined based on a recommendation of the manufacturer of the equipment. In some implementations, the threshold vibration level is determined based on historical vibration measurements, that is, measurement of vibration of the hydrocarbon recovery equipment taken during past uses, in particular, vibrations that resulted in equipment failure. As described above, each vibration sensor transforms the sensed vibration into an electrical signal having an amplitude that is based on and is representative of the sensed vibration. In some implementations, using the same transformation as the vibration sensor, the vibration controller 116 converts each threshold vibration level into an electrical signal value that is representative of the threshold vibration level. The vibration controller 116 stores multiple such electrical signal values collectively representing the threshold vibration levels of the multiple hydrocarbon recovery equipment. In some implementations, the vibration controller 116 stores the threshold vibration level as a frequency value or an amplitude value or both, that is, without transforming the frequency value or the amplitude value into an electrical signal value. In such implementations, the vibration controller 116 is configured to transform the electrical signal value received from the vibration sensor into the sensed vibration (frequency or amplitude or both) sensed by the vibration sensor.

In some implementations, each vibration sensor that is connected to a hydrocarbon recovery equipment transmits sensed vibrations to the vibration controller 116. For example, each vibration sensor transforms the sensed vibration into an electrical signal value and transmits the electrical signal value to the vibration controller 116. The vibration controller 116 compares the vibrations received from the vibration sensor to the threshold vibration level associated with the hydrocarbon recovery equipment to which the vibration sensor is connected. For example, each vibration sensor is associated with a unique identifier. Each vibration sensor is configured to include its unique identifier in the signal that carries the sensed vibration to the vibration controller 116. The vibration controller 116 stores multiple unique identifiers and, with each unique identifier identifying a vibration sensor, maps the threshold vibration level associated with the hydrocarbon recovery equipment to which that vibration sensor is connected. Upon receiving a signal that carries a unique identifier and a sensed vibration, the vibration controller 116 can search the multiple unique identifiers to identify the corresponding vibration sensor. The vibration controller 116 can compare the vibrations carried in the signal with the threshold vibration level mapped to the unique identifier. The comparison reveals that the vibration sensed by the hydrocarbon recovery equipment is less than or greater than the threshold vibration level associated with that equipment.

Based on a result of the comparing, the vibration controller 116 can transmit an alert signal to an alarm system 118 on the surface 104. In some implementations, the alarm system 118 can include a speaker that can output an audible alarm that is sufficiently loud for a human operator to hear. In some implementations, the alarm system 118 can include a light source that can output an optical signal (for example, a light) that is visible to the human operator. In some implementations, the alarm system can output an audible alarm and an optical signal. The alarm system 118 and the vibration controller 116 can be connected by wired or wireless connections through which the alert signal can be transmitted.

In one example, if the vibration controller 116 determines that the vibration received from a hydrocarbon recovery equipment exceeds the stored threshold vibration level associated with that equipment, then the vibration controller 116 can transmit the alert signal (for example, an electrical signal or a data signal) to the alarm system 118. The alarm system 118 can emit the alert signal (for example, the acoustic alarm or optical alarm) in response to receiving the alert signal. In response, the human operator can take corrective action, for example, shut down the hydrocarbon recovery equipment, decrease a speed of operation, evacuate the area, or take other corrective action. In some implementations, either the vibration controller 116 or the alarm system 118 (or both) can include a display device that can display an identity of the hydrocarbon recovery equipment whose vibrations exceed the threshold vibration level. For example, the vibration controller 116 can display the unique identifier of the hydrocarbon recovery equipment in the display device. Alternatively or in addition, the vibration controller 116 can include the unique identifier of the hydrocarbon recovery equipment in the alert signal transmitted to the alarm system 118 to be displayed in the display device of the alarm system 118. In another example, the alarm system 118 can emit different colored light (for example, yellow light for low risk, orange light for medium risk, red light for high risk) or different type of sound for the different hydrocarbon recovery equipment. FIG. 3 is a flowchart of an example of a process 300 of monitoring vibration in hydrocarbon recovery equipment. The process 300 can be implemented, in part, by the vibration controller 116 and, in part, by a human operator. The process 300 can be implemented to monitor vibrations of hydrocarbon recovery equipment on the surface of the Earth resulting from operating such equipment in hydrocarbon recovery processes, for example, wellbore forming or production or both. In initial steps, operators of the equipment can attach (that is, physically and directly connect) a vibration sensor to each hydrocarbon recovery equipment on the surface of the Earth. The multiple vibration sensors sense vibration of the respective hydrocarbon recovery equipment, for example, through conduction.

At 302, a portion of vibrations of the hydrocarbon recovery equipment on a surface of the Earth is sensed by a vibration sensor. All the vibration sensors connected to all the hydrocarbon recovery equipment perform step 302. At 304, the sensed vibrations are transmitted to the vibration controller 116. All the vibration sensors perform step 304 as well. At 306, the sensed vibrations are compared to a threshold vibration level associated with the equipment. The vibration controller 116 performs step 306 for vibrations received from all the vibration sensors. At 308, an alarm is triggered if the sensed vibrations exceed the threshold level. For each instance of sensed vibrations from a vibration sensor exceeding the threshold vibration level associated with the hydrocarbon recovery equipment to which that vibration sensor is attached, the vibration controller 116 transmits an alert signal to the alarm system 118. The alarm system 118 emits an alarm signal (for example, an acoustic signal or an optical signal) for each hydrocarbon recovery equipment experiencing vibrations greater than the respective threshold vibration level.

In sum, this disclosure describes monitoring vibrations on above-surface hydrocarbon recovery equipment caused by hydrocarbon recovery operations including operations implemented within a wellbore. In some instances, implementing the operations within the wellbore cause the above-surface equipment to vibrate at levels that exceed threshold vibration levels associated with the equipment. By implementing the techniques described here, the equipment experiencing excessive vibrations can be immediately identified and remedial actions taken, thereby avoiding equipment damage or failure, operational downtime and harm to operators of the equipment.

Thus, particular implementations of the subject matter have been described. Other implementations are within the scope of the following claims.

1. A method comprising:
sensing, by a vibration sensor connected to a hydrocarbon recovery equipment operating on a surface of the Earth, a portion of vibrations of the hydrocarbon recovery equipment when performing operations to recover hydrocarbons from a subterranean zone;
transmitting, by the vibration sensor and to a vibration controller on the surface, the portion of vibrations, the vibration controller disposed on the surface of the Earth;
comparing, by the vibration controller, the portion of vibrations sensed by the vibration sensor to a stored threshold vibration level associated with the hydrocarbon recovery equipment;
based on a result of the comparing, transmitting, by the vibration controller, an alert signal to an alarm system on the surface; and
in response to receiving the alert signal, emitting, by the alarm system, an acoustic or optical alarm signal representing the result of the comparing.

2. The method of claim 1, wherein the vibration sensor is directly connected to the hydrocarbon recovery equipment, and wherein the portion of vibrations is sensed by acoustic conduction.

3. The method of claim 1, further comprising transforming, by the vibration sensor, the portion of vibrations into electrical signals, wherein the electrical signals are transmitted to the vibration controller.

4. The method of claim 3, wherein the electrical signals are transmitted to the vibration controller through wired connections between the vibration sensor and the vibration controller.

5. The method of claim 3, wherein the stored threshold vibration level associated with the hydrocarbon recovery equipment is based on a resonance frequency of the hydrocarbon recovery equipment, wherein the stored threshold vibration level is stored as an electrical signal value.

6. The method of claim 5, wherein comparing, by the vibration controller, the portion of vibrations sensed by the vibration sensor to a stored threshold vibration level associated with the hydrocarbon recovery equipment comprises comparing the electrical signals received by the vibration controller with the electrical signal value stored by the vibration controller.

7. The method of claim 1, wherein the alert signal is an electrical signal transmitted to the alarm system through wired connections.

8. The method of claim 1, wherein the hydrocarbon recovery equipment is a first hydrocarbon recovery equipment of a plurality of hydrocarbon recovery equipment, each operating on the surface, each connected to the vibration controller, wherein the method further comprises:
storing, by the vibration controller, a plurality of stored threshold vibration levels, each associated with a respective hydrocarbon recovery equipment of the plurality of hydrocarbon recovery equipment;
comparing, by the vibration controller, vibrations of each hydrocarbon recovery equipment with a respective stored threshold vibration level associated with the hydrocarbon recovery equipment; and
transmitting, by the vibration controller, a respective alert signal associated with the hydrocarbon recovery equipment based on a result of comparing the vibrations of each hydrocarbon recovery equipment with a respective stored threshold vibration level associated with the hydrocarbon recovery equipment.

9. A hydrocarbon recovery equipment vibration control system comprising:
a vibration sensor connected to a hydrocarbon recovery equipment operating on a surface of the Earth, the vibration sensor configured to sense a portion of vibrations of the hydrocarbon recovery equipment when performing operations to recover hydrocarbons from a subterranean zone;
a vibration controller disposed on the surface, the vibration controller connected to the vibration sensor, the vibration controller configured to perform operations comprising:
receiving, from the vibration sensor, the portion of vibrations,
comparing the portion of vibrations to a stored threshold vibration level associated with the hydrocarbon recovery equipment, and
based on a result of the comparing, transmitting an alert signal; and
an alarm system disposed on the surface, the alarm system connected to the vibration controller, the alarm system configured to perform operations comprising:
receiving, from the vibration controller, the alert signal, and
in response to receiving the alert signal, emitting an acoustic or optical alarm signal representing the result of the comparing.

10. The system of claim 9, wherein the vibration sensor is directly connected to a portion of the hydrocarbon recovery equipment which experiences more vibration during operation of the hydrocarbon recovery equipment compared to a remainder of the hydrocarbon recovery equipment.

11. The system of claim 9, wherein the vibration sensor is an ultrasonic vibration sensor.

12. The system of claim 9, wherein the vibration sensor comprises a transducer configured to transform the portion of vibrations to electrical signals.

13. The system of claim 12, wherein the vibration sensor and the vibration controller are connected through wired connections through which the vibration sensor transmits the electrical signals to the vibration controller.

14. The system of claim 9, wherein the vibration controller comprises:
a computer-readable memory configured to store the stored threshold vibration level as an electrical signal value; and
one or more processors configured to compare a value of the electrical signals to the electrical signal value.

15. The system of claim 9, wherein the stored threshold vibration level associated with the hydrocarbon recovery equipment is based on a resonance frequency of the hydrocarbon recovery equipment.

16. A hydrocarbon recovery equipment system comprising:
a plurality of hydrocarbon recovery equipment, each hydrocarbon recovery equipment configured to be disposed on a surface of the Earth, each hydrocarbon recovery equipment experiencing vibrations when operating on the surface of the Earth to recover hydrocarbons from a subterranean zone;
a plurality of vibration sensors, each vibration sensor directly attached to a respective hydrocarbon recovery equipment, each vibration sensor configured to sense vibrations of the respective hydrocarbon recovery equipment and transmit the sensed vibrations;
a vibration controller connected to the plurality of vibration sensors, the vibration controller configured to receive a plurality of sensed vibrations from the respective plurality of vibration sensors, the vibration controller configured to store a plurality of vibration threshold levels, each vibration threshold level associated with a respective hydrocarbon recovery equipment, the vibration controller configured to compare the plurality of sensed vibrations and the plurality of vibration threshold levels; and
an alarm system connected to the vibration controller, the alarm system configured to output an acoustic or optical alarm in response to the vibration controller determining that a sensed vibration from any of the plurality of hydrocarbon recovery equipment exceeds the respective stored vibration threshold level.

17. The system of claim 16, wherein the plurality of hydrocarbon recovery equipment comprises rotating machines and electric machines.

18. The system of claim 16, wherein each vibration threshold level associated with a respective hydrocarbon recovery equipment is based on a resonance frequency of a material using which the respective hydrocarbon recovery equipment is made.

19. The system of claim 16, wherein the plurality of vibration sensors are connected to the vibration controller through wired connections.
